(19) United States
(12) Patent Application Publication
(10) Pub. No.: US 2009/0089743 A1
(43) Pub. Date: Apr. 2, 2009

(54) Methods and Apparatus for IDE Integration of Database Changes

(76) Inventors: Eric L. Barsness, Pine Island, MN (US); Daniel E. Beuch, Rochester, MN (US); Paul S. Nelsestuen, Oronoco, MN (US); John M. Santosuosso, Rochester, MN (US)

Correspondence Address: IBM Corporation;Matthew C. Zehrer, Intellectual Property Law Dept. 917, 3605 Hwy. 52 North, Rochester, MN, 55901, US

(21) Appl. No.: 11/865,995

(22) Filed: Oct. 2, 2007

(51) Int. Cl. G06F 9/44

(52) U.S. Cl. 717/106

(57) ABSTRACT

In one aspect, a method is provided. The method includes (1) generating code in an integrated development environment (IDE), the code including instructions for a database; and (2) receiving feedback in the IDE, the feedback relating to the instructions for the database.

### FIELD OF THE INVENTION

The present invention relates generally to integrated development environments and, more particularly, to methods and apparatus for integrated development environment integration of database changes.

### BACKGROUND

Integrated development environments (IDEs) are a predominant vehicle used to develop modern applications. IDEs are offered by companies such as IBM, Microsoft, Borland, and PowerBuilder.

One of the common features of today's IDEs is the ability to “plug in” different options. For example, IBM's rational IDE (built on Eclipse) has plug-in capabilities and even the capability for users to add their own plug-ins. Another common feature is the ability to connect the IDE to a remote system such that while developing code, the IDE can automatically generate database instructions (such as SQL statements) in the code from tables accessible to the connected system (e.g., Remote System Explorer in WDSC).

### SUMMARY OF THE INVENTION

In a first aspect of the invention, a method is provided. The method may include: (1) generating code in an integrated development environment (IDE), the code including instructions for a database; and (2) receiving feedback in the IDE, the feedback relating to the instructions for the database.

In a second aspect of the invention, a device is provided. The device may include: (1) an IDE; and (2) logic, coupled to the IDE, and to: (a) generate code in the IDE, the code including instructions for a database; and (b) receive feedback in the IDE, the feedback related to the instructions for the database.

In a third aspect of the invention, a system is provided. The system may include: (1) an IDE device including an IDE; (2) a database device including a database; and (3) logic, coupled to at least one of the IDE device and the database device, and to: (a) generate code in the IDE, the code including instructions for a database; and (b) receive feedback in the IDE, the feedback related to the instructions for the database.

Other features and aspects of the present invention will become more fully apparent from the following detailed description, the appended claims and the accompanying drawings.

### BRIEF DESCRIPTION OF THE FIGURES

FIG. 1 is a block diagram of an integrated development environment (IDE) system in accordance with an embodiment of the present invention;

FIG. 2 illustrates an exemplary method of checking for database changes in accordance with an embodiment of the present invention;

FIG. 3 illustrates an exemplary method of communicating performance information in accordance with an embodiment of the present invention; and

FIG. 4 illustrates an exemplary method of checking for performance changes in accordance with an embodiment of the present invention.

### DETAILED DESCRIPTION

While plug-in capabilities and remote system connectivity may make programming using an integrated development environment (IDE) easier, these features fail to take the extra step to identify potential problems come deployment time. Stated another way, while an IDE is connected to a system such that it may generate database instructions (such as SQL statements) that may be used by an application, there should be a plug-in to the IDE environment that will feed information back to the IDE about potential runtime issues involving the database instructions.

Embodiments of the present invention provide methods and apparatus for IDE integration of database changes. More specifically, code including instructions for a database may be generated in an IDE, and feedback relating to the instructions may be received in the IDE. The feedback may include database change feedback, performance feedback, and/or performance change feedback.

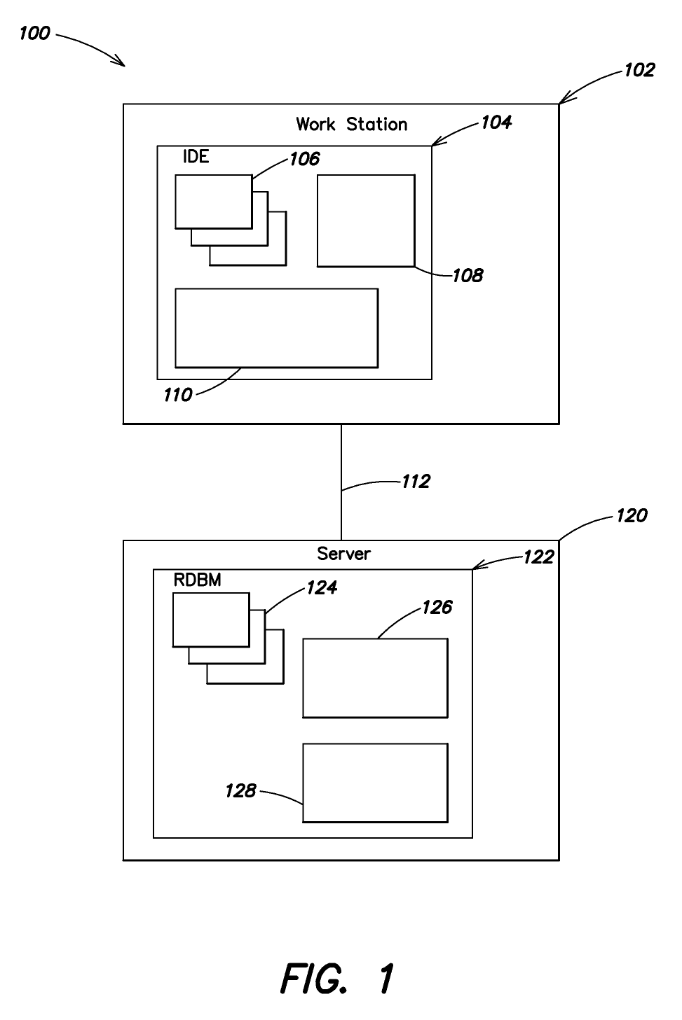

FIG. 1 is a block diagram of an IDE system 100 in accordance with an embodiment of the present invention. The IDE system 100 may include a workstation 102 and a server 120 connected via a connection 112.

The workstation 102 may include an IDE 104 including code 106, historical query performance data 108 for database instructions (SQL statements in this exemplary embodiment) in the code, and historical table metadata 110. The server 120 may include a relational database manager 122 including tables 124, table metadata 126, and query performance data 128 for SQL statements in the code. The table metadata 126 may include information about the tables 124, including indexes, constraints, column names, and column types. The query performance data 128 may include current or real-time data as compared with the historical query performance data 108.

The IDE 104 may be used to develop the code 106. The historical query performance data 108 may be compared with the query performance data 128 to identify query performance degradation. The historical table metadata 110 may be compared with the table metadata 126 to identify changes in the table metadata 126.

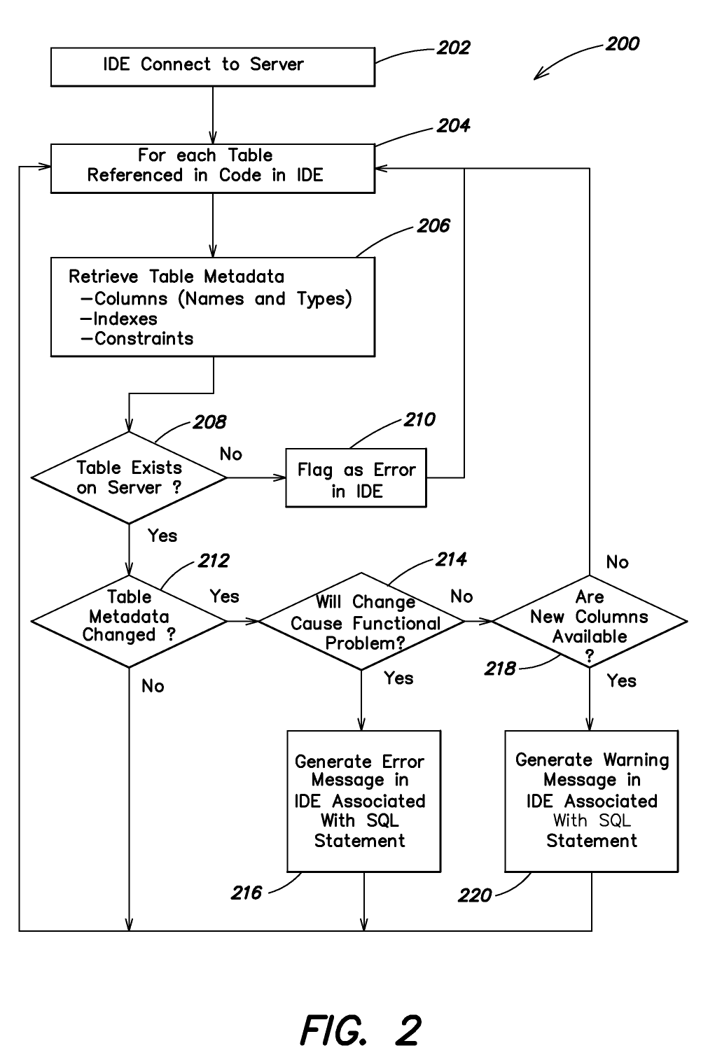

The operation of the IDE system 100 is now described with reference to FIGS. 2-4 which illustrate exemplary methods in accordance with embodiments of the present invention. FIG. 2 illustrates an exemplary method 200 of checking for database changes in accordance with an embodiment of the present invention. In operation 202, the IDE 104 may connect to the server 120. Operation 204 and subsequent operations may be performed for each of the tables 124 referenced in the code 106. In operation 206, table metadata 126 may be retrieved. In operation 208, a determination may be made whether the table exists on the server 120. The table may not exist on the server 120, for example, if the table is removed from, deleted from, or renamed on the server 120. If a decision is made that the table does not exist on the server 120, the reference to the table in the code 106 may be flagged with an error in the IDE 104. If a decision is made that the table does exist on the server 120, the method 200 may proceed to operation 212.

In operation 212, a determination may be made whether the table metadata 126 has changed. An exemplary table metadata 126 change may be a column type change, such as from an integer column type to a string column type. This determination may be made by comparing the table metadata 126 with the historical table metadata 110. If a decision is made that the table metadata 126 has not changed, the method 200 may proceed to operation 204. If a decision is made that the table metadata 126 has changed, the method 200 may proceed to operation 214.

In operation 214, a determination may be made whether the change to the table metadata 126 will cause a functional problem. If a decision is made that the change to the table metadata 126 will cause a functional problem, an error message associated with the relevant portion of the code 106 (e.g., a particular SQL statement) may be generated in the IDE 104 in operation 216, and the method 200 may proceed to operation 204. If a decision is made that the change to the table metadata 126 will not cause a function problem, then the method 200 may proceed to operation 218.

In operation 218, a determination may be made whether new columns are available. If a decision is made that new columns are available, a warning message associated with the relevant portion of the code 106 (e.g., a particular SQL statement) may be generated in the IDE 104 in operation 220, and the method 200 may proceed to operation 204. The warning message may be for informational purposes to bring awareness to a user of the new column(s). If a decision is made that new columns are not available, the method 200 may proceed to operation 204.

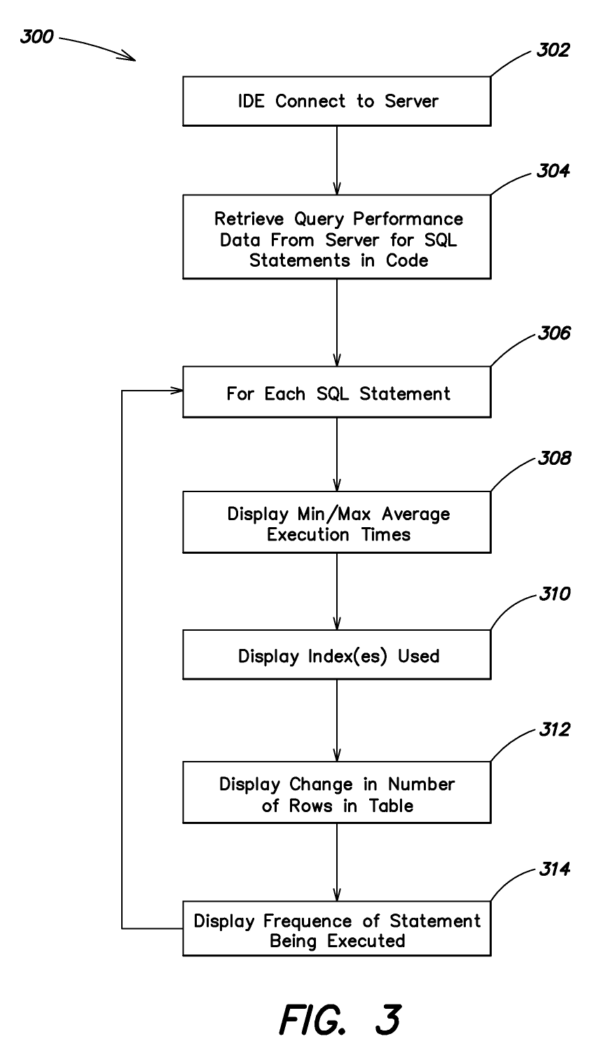

FIG. 3 illustrates an exemplary method 300 of communicating performance information in accordance with an embodiment of the present invention. The performance information may be communicated for informational purposes to the IDE 104. In operation 302, the IDE 104 may connect to the server 120. In operation 304, query performance data 128 may be retrieved from the server 104 for SQL statements in the code 106. Operation 306 and subsequent operations may be performed for each SQL statement in the code 106. In operation 308, min/max/average execution times may be displayed in the IDE 104. In operation 310, index(es) used may be displayed in the IDE 104. In operation 312, changes in the number of rows in a table may be displayed in the IDE 104. In operation 314 the frequency of a statement being executed may be displayed in the IDE 104. The method 300 may proceed to operation 306.

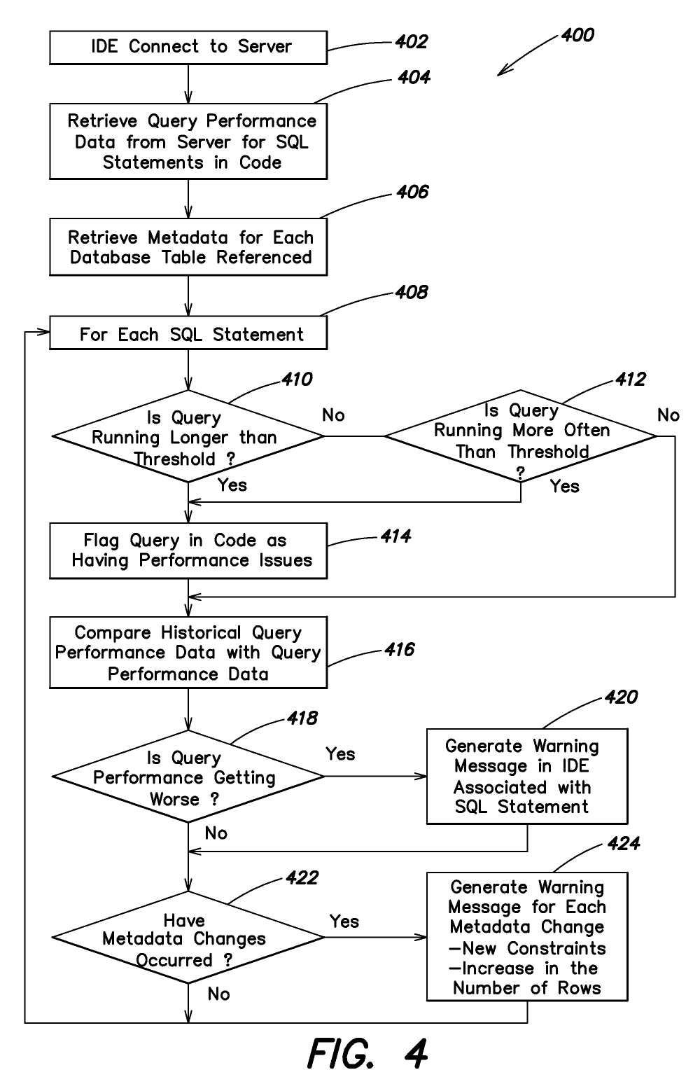

FIG. 4 illustrates an exemplary method 400 of checking for performance changes in accordance with an embodiment of the present invention. In operation 402, the IDE 104 may connect to the server 120. In operation 404, query performance data 128 may be retrieved from the server 120 for SQL statements in the code 106. In operation 406, table metadata 126 may be retrieved from the server 120 for each of the tables 124 referenced in the code 106. Operation 408 and subsequent operations may be performed for each SQL statement in the code 106. In operation 410, a determination may be made whether a query is running longer than a threshold amount. If a decision is made that the query is running longer than the threshold amount, a reference to the query in the code 106 may be flagged in the IDE 104 as having performance issues in operation 414. If a decision is made that the query is not running longer than the threshold amount, the method 400 may proceed to operation 412.

In operation 412, a determination may be made whether the query is running more often than a threshold amount. If a decision is made that the query is running more often than the threshold amount, a reference to the query in the code 106 may be flagged in the IDE 104 as having performance issues in operation 414. If a decision is made that the query is not running more often than the threshold amount, the method 400 may proceed to operation 416.

In operation 416 and subsequent operations, historical query performance data 108 may be compared with query performance data 128. In operation 418, a determination may be made whether query performance is getting worse. If a decision is made that query performance is getting worse, a warning message associated with the SQL statement may be generated in the IDE 104 in operation 420. The method 400 may proceed to operation 422. If a decision is made that query performance is not getting worse, the method 400 may proceed to operation 422.

In operation 422, a determination may be made whether metadata changes (e.g., new constraints, an increase in the number of rows of a table) have occurred. If a decision is made that metadata changes have occurred, a warning message for each metadata change may be generated in the IDE 104 in operation 424. The method 400 may proceed to operation 408. If a decision is made that metadata changes have not occurred, the method 400 may proceed to operation 408.

The foregoing description discloses only exemplary embodiments of the invention. Modifications of the above-disclosed embodiments of the present invention of which fall within the scope of the invention will be readily apparent to those of ordinary skill in the art. For instance, although in some embodiments, the workstation 102 and the server 120 are described as separate units connected via the connection 112, in the other embodiments, the workstation 102 and the server 120 may be a single unit. Further, although in some embodiments, the code 106, the historical query performance data 108, and the historical table metadata 110 may be depicted as part of the IDE 104, in other embodiments, the code 106, the historical query performance data 108, and/or the historical table metadata 110 may be accessed by the IDE 104. Further, although in some embodiments, the tables 124, the table metadata 126, and the query performance data 128 may be depicted as part of the relational database manager 122, in other embodiments, the tables 124, the table metadata 126, and/or the query performance data 128 may be accessed by the relational database manager 122.

Accordingly, while the present invention has been disclosed in connection with exemplary embodiments thereof, it should be understood that other embodiments may fall within the spirit and scope of the invention as defined by the following claims.

The invention claimed is:

1. A method, comprising:
generating code in an integrated development environment (IDE), the code including instructions for a database; and
receiving feedback in the IDE, the feedback relating to the instructions for the database.

2. The method of claim 1, wherein the receiving of feedback in the IDE comprises:
receiving database change feedback in the IDE.

3. The method of claim 2, wherein the receiving of database change feedback in the IDE comprises:
receiving at least one of an indication that a table referenced in the code does not exist, an indication that a metadata change for a table referenced in the code will cause a functional problem in the code, and an indication that a new column of a table referenced in the code is available.

4. The method of claim 1, wherein the receiving of feedback in the IDE comprises:
receiving performance feedback in the IDE.

5. The method of claim 4, wherein the receiving of performance feedback in the IDE comprises:
receiving at least one of a min/max/average execution time indication, an index used indication, a change in number of rows in table indication, and a frequency of statement being executed indication.

6. The method of claim 1, wherein the receiving of feedback in the IDE comprises:
receiving performance change feedback in the IDE.

7. The method of claim 6, wherein the receiving of performance change feedback in the IDE comprises:
receiving at least one of a query running longer than threshold indication, a query running more often than threshold indication, a query performance getting worse indication, and a metadata change indication.

8. An apparatus, comprising:
an IDE;
logic, coupled to the IDE, and to:
generate code in the IDE, the code including instructions for a database; and
receive feedback in the IDE, the feedback related to the instructions for the database.

9. The apparatus of claim 8, wherein the logic coupled to the IDE to receive feedback in the IDE comprises logic to receive database change feedback in the IDE.

10. The apparatus of claim 9, wherein the logic to receive database change feedback in the IDE comprises logic to receive at least one of an indication that a table referenced in the code does not exist, an indication that a metadata change for a table referenced in the code will cause a functional problem in the code, and an indication that a new column of a table referenced in the code is available.

11. The apparatus of claim 8, wherein the logic coupled to the IDE to receive feedback in the IDE comprises logic to receive performance feedback in the IDE.

12. The apparatus of claim 11, wherein the logic to receive performance feedback in the IDE comprises logic to receive at least one of a min/max/average execution time indication, an index used indication, a change in number of rows in table indication, and a frequency of statement being executed indication.

13. The apparatus of claim 8, wherein the logic coupled to the IDE to receive feedback in the IDE comprises logic to receive performance change feedback in the IDE.

14. The apparatus of claim 13, wherein the logic to receive performance change feedback in the IDE comprises logic to receive at least one of a query running longer than threshold indication, a query running more often than threshold indication, a query performance getting worse indication, and a metadata change indication.

15. A system, comprising:
an IDE device including an IDE;
a database device including a database; and
logic, coupled to at least one of the IDE device and the database device, and to:
generate code in the IDE, the code including instructions for a database; and
receive feedback in the IDE, the feedback related to the instructions for the database.

16. The system of claim 15, wherein the logic coupled to at least one of the IDE device and the database device to receive feedback in the IDE comprises logic to receive database change feedback in the IDE.

17. The system of claim 16, wherein the logic to receive database change feedback in the IDE comprises logic to receive at least one of an indication that a table referenced in the code does not exist, an indication that a metadata change for a table referenced in the code will cause a functional problem in the code, and an indication that a new column of a table referenced in the code is available.

18. The system of claim 15, wherein the logic coupled to at least one of the IDE device and the database device to receive feedback in the IDE comprises logic to receive performance feedback in the IDE.

19. The system of claim 18, wherein the logic to receive performance feedback in the IDE comprises logic to receive at least one of a min/max/average execution time indication, an index used indication, a change in number of rows in table indication, and a frequency of statement being executed indication.

20. The system of claim 15, wherein the logic coupled to at least one of the IDE device and the database device to receive feedback in the IDE comprise logic to receive performance change feedback in the IDE.

21. The system of claim 15, wherein the logic to receive performance change feedback in the IDE comprises logic to receive at least one of a query running longer than threshold indication, a query running more often than threshold indication, a query performance getting worse indication, and a metadata change indication.
